(19) United States
(12) Patent Application Publication
(10) Pub. No.: US 2009/0106369 A1
(43) Pub. Date: Apr. 23, 2009

(54) DUPLICATE EMAIL ADDRESS DETECTION FOR A CONTACT

(76) Inventors: Yen-Fu Chen, Austin, TX (US); Fabian F. Morgan, Austin, TX (US); Keith R. Walker, Austin, TX (US); Sarah V. White Eagle, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/874,758

(22) Filed: Oct. 18, 2007

(51) Int. Cl. G06F 15/16

(52) U.S. Cl. 709/206

(57) ABSTRACT

Methods, systems, and media are disclosed for managing multiple email addresses, each of which are associated with a known contact, e.g., a specific person. One embodiment includes selecting email addresses for an email to be sent through a computer system in communication with a mail server, wherein the email addresses comprise an email distribution list. Further, the method includes querying, before sending the email, for duplicate contacts associated with the email addresses in the email distribution list for the email. Further still, the method includes updating, after the querying, the email distribution list to the email addresses left in a remaining email distribution list produced through removal, if any, of the duplicate contacts identified by the querying. Finally, the method includes sending the email to contacts associated with each of the email addresses in the remaining email distribution list, wherein the contacts are in communication with the mail server.

### FIELD OF INVENTION

The invention generally relates to devices, methods, and media for duplicate email detection intended for the same, known person, and then removal of duplicate emails prior to sending an email.

### BACKGROUND

Electronic mail (“email”) is an electronic message, which a person may type at a computer system, such as a personal digital assistant (“PDA”) or conventional computer, and then transmit the email over a computer network to another person. For a user to type an email, the computer system includes an email client (“client”), which is an application used to read, write and send email. In simple terms, the client, such as in Outlook®, Eudora®, or AOL®, is the user interface for an electronic messaging system.

Typically, the email client includes a simple text editor, an address book, a filing cabinet and a communications module. The text editor allows the user to compose a text message for an email, and usually includes spell and grammar checking as well as formatting facilities. The text editor may also include the ability to append attachments to an email such as files, documents, executable programs, schematics, etc. The address book stores commonly used email addresses in a convenient format to reduce the chance of email address errors. The filing cabinet stores email messages, both sent and received, and usually includes a search function for easy retrieval of a desired email or email attachment. The communications module deals with transport to and from the email client over a computer network to a mail server, the application that receives an email from email clients and/or other mail servers.

As is commonplace, especially with today's intermingling of personal and professional lives, many people have more than one email account from which to send and receive emails. For instance, oftentimes, the same person (i.e., “contact”) has an email account through work, through an internet service provider, e.g., AOL® and Earthlink®, and through free web-based providers, e.g., Gmail® by Google® and Hotmail® by MSN®. Whether purposefully or accidentally, the same person will give out, say, a personal email address to a colleague and a work email address to a friend, and others will collect both personal and work emails for the same person through email forwards and the like; as a result, one can end up with multiple email addresses for the same person/contact and not even know it. Furthermore, when a person sends the same email to multiple email accounts belonging to the same person, or, a person receives through an email client receiving email from the same person's multiple email accounts, unnecessary bandwidth use and traffic may occur as described below.

A computer network, such as one belonging to a business organization, consists of a number of computer systems interconnected with links for transmission of data between the computer systems, which serve as conduits to send an email to a recipient. In addition to handling email traffic, with or without email attachments, it is noteworthy to point out that these computer systems also handle the everyday rigors of an organization's use, including, for example, storing and retrieving documents, running multiple applications and operating systems, and so forth. The physical design of each link limits the bandwidth for the link. Bandwidth refers to the amount of data that can be transmitted in a fixed amount of time. The topology of the network, i.e., the organization, number, and interconnection between links of the network, can be designed to increase bandwidth between different points on the network by providing parallel links. Therefore, design of the bandwidth and topology for these networks must take into consideration all traffic, finding a balance between the costs involved with increasing bandwidths of links and the slowdowns when the bandwidths are less than the peak traffic requirements.

Compromising the network's capacity more so is the handling of email traffic when the emails include email attachments. Email attachments can cause the traffic bandwidth requirements to peak, slowing down the network for everyday operations. For example, a user may draft a text email, which is about 20 kilobytes, and transmit the email to ten people. As a result, the mail server introduces 200 kilobytes of data to the network when the mail server generates a copy of the email for each of the ten recipients. Even small networks are likely able handle 200 kilobytes without any noticeable slowdowns. However, the user may decide to transmit a drawing, which may be somewhere between 2 megabytes and 20 megabytes, along with the text of the email to enhance the communication. Now, the mail server copies not only the email, but also the email attachment and introduces between 22 megabytes and 202 megabytes of data traffic at substantially the same time, peaking the load, at least in certain links, of even large networks. This makes the network run slower for other users. Possibly even more troublesome, however, is from the employer's perspective: multiple emails to the same person may decrease a worker's productivity because the same person is expending time reading the same email sent to another email account for the same person.

Some solutions attempt to alleviate email traffic congestion by “throwing more money at the problem.” That is, to solve the congestion problem by increasing the size of the network by increasing the network's bandwidth. In order to display, store, and retrieve data, the network must have computer systems such as dedicated mail servers of sufficient size to accommodate the data traffic requirements. Therefore, increasing a network's bandwidth necessarily requires an organization to make greater expenditures or institute restrictions on use of the network's computer systems to keep pace with the increased demands. Further, the purchase of additional hardware components necessarily increases the mail server administrator's involvement in handling the ever-increasing email traffic over an organization's network, resulting in greater administrative costs. These types of solutions, however, are piecemeal solutions that will forever require greater expenditures or restrictions as an organization grows. In short, these solutions are not solutions; they are patches for network problems.

A need, therefore, exists for devices, methods and media to attenuate the foregoing problems by email systems being able to detect and eliminate duplicate email accounts for the same person in email distribution lists, which are the email accounts or groups comprising email accounts conventionally found in the “to”, “cc” or “bcc” fields of an email before sending the email.

### SUMMARY OF THE INVENTION

Embodiments of the invention generally provide methods, systems, and media for managing multiple email addresses, each of which are associated with known contacts, e.g., a person or a computer instrument capable of receiving emailed instructions. One embodiment includes selecting email addresses for an email to be sent through a computer system in communication with a mail server, wherein the email addresses comprise an email distribution list. Further, the method includes querying, before sending the email, for duplicate contacts associated with the email addresses in the email distribution list for the email. Further still, the method includes updating, after the querying, the email distribution list to the email addresses remaining in the email distribution list. Finally, the method includes sending the email to contacts associated with each of the email addresses remaining in the email distribution list, wherein the contacts are in communication with the mail server.

In another embodiment, the invention provides a system for managing multiple email addresses. The system includes email addresses selected for an email to be sent through a computer system having an email client and in communication with a mail server, wherein the email addresses comprise an email distribution list. In addition, the system includes an interrogation module, associated with the email client, for querying, before sending the email, for duplicate contacts associated with any of the email addresses in the email distribution list for the email. Furthermore, the system includes an update module, associated with the interrogation module, for updating the email distribution list to the email addresses left in a remaining email distribution list produced through removal, if any, of the duplicate contacts identified by the querying by the interrogation module. Finally, the system includes a completion module for sending the email to contacts associated with each of the email addresses in the remaining email distribution list in communication with the mail server.

In yet another embodiment, the invention provides a machine-accessible medium containing instructions for managing multiple email addresses, each of which are associated with known contacts, and when the instructions are executed by a machine, they cause the machine to perform operations. The instructions generally include operations for selecting email addresses for an email to be sent through a computer system in communication with a mail server, wherein the email addresses comprise an email distribution list. The instructions further include operations for querying, before sending the email, for duplicate contacts associated with the email addresses in the email distribution list for the email. Further still, the instructions include operations for updating, after the querying, the email distribution list to the email addresses remaining in the email distribution list. Finally, the instructions include operations for sending the email to contacts associated with each of the email addresses remaining in the email distribution list, wherein the contacts are in communication with the mail server.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts an example embodiment of a system including an email client associated with a computer system in communication with a mail server for permitting the management of multiple email addresses for a contact by detecting and optionally removing duplicate contacts, i.e., the same person or entity, associated with different email addresses in an email distribution list for an email to be sent in accordance with the disclosed invention.

FIG. 2 depicts an example embodiment of a system for managing multiple email addresses for a contact by detecting and optionally removing duplicate contacts, i.e., the same person or entity, associated with different email addresses in an email distribution list for an email to be sent in accordance with the disclosed invention.

FIG. 3 depicts an example embodiment of a method for managing multiple email addresses for a contact by detecting and optionally removing duplicate contacts, i.e., the same person or entity, associated with different email addresses in an email distribution list for an email to be sent in accordance with the disclosed invention.

FIG. 4 depicts a computer system capable of being a networked computer system or computer system connected to the networked computer system as discussed in this disclosure, when provided with the appropriate messaging service software, for use in managing multiple email addresses for a contact.

### DETAILED DESCRIPTION OF THE EMBODIMENTS

The following is a detailed description of example embodiments of the invention depicted in the accompanying drawings. The embodiments are examples and are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, devices, methods, and media for managing multiple email addresses by detecting and optionally removing duplicate contacts, i.e., the same person or entity, associated with different email addresses in an email distribution list for an email to be sent are contemplated. Embodiments include selecting more than two email addresses for an email to be sent from a computer system having an email client in wired or wireless communication with at least one mail server. The two or more email addresses in the email to be sent constitute an email distribution list (“EDL”) for that email. By the email sender pressing a “send” button, for instance, in an email client, what may be termed a multiple email address manager is invoked before the email is actually sent to any intended recipients, i.e., contacts, of the email. Whether a downloadable plug-in or integrated into an email client on the client or server side, the multiple email address manager queries for duplicate contacts associated with the two or more email addresses in the EDL for the email to be sent. Since each email address is associated with a contact, and a contact may have more than one email address, the point of the querying is to determine whether the same contact, i.e., a duplicate contact, will be receiving the email based on the two or more email addresses selected for the email to be sent. By querying with various types of enabling logic reduced to software and/or hardware, the multiple email address manager may detect one or more duplicate contacts for the email to be sent. Upon detection, if any, of a duplicate contact identified by the querying, the multiple email address manager may automatically update the EDL to produce a remaining EDL, which may simply result by removing one of the email addresses for the duplicate contact so that the contact only receives one copy of the email rather than two or more; instead of automatically updating the remaining EDL, the multiple email address manager may optionally prompt a user, for instance, to confirm or deny whether a possible duplicate contact was properly identified by the querying before updating the remaining EDL for the email to be sent. This querying and updating may occur repeatedly until there are no more duplicate contacts detected, whereupon the multiple email address manager may either send, itself, or pass back to the email client to send the email those on the remaining EDL through one or more mail servers in communication with the same or a different computer system(s) as the email client sending the email.

Advantageously, embodiments of the present invention reduce or attenuate instantaneous data traffic on a computer system's network by reducing the number of emails, and any attachments thereto, sent on a remaining EDL for an email. In addition, embodiments may be implemented in a single email client, i.e., client-side, without requiring installation of software or additional hardware in a mail server by an administrator. However, server-side installation is equally possible for the multiple email address manager.

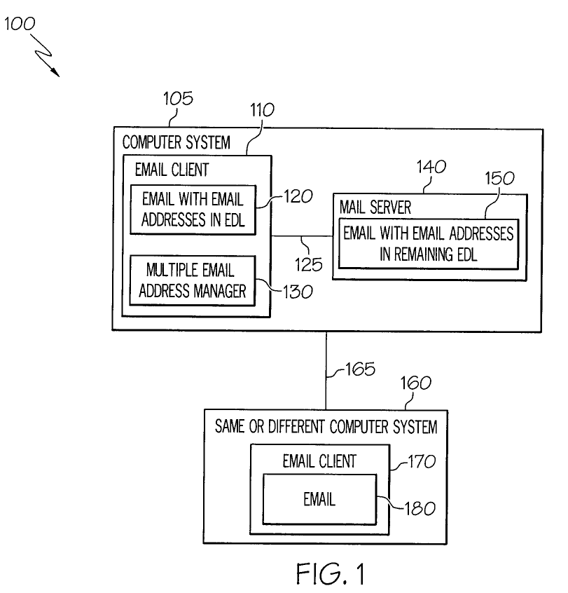

Turning now to the drawings, FIG. 1 depicts an embodiment of a system 100 for managing multiple email addresses by detecting and optionally removing one or more duplicate contacts in an email to be sent. Before turning to a detailed discussion of FIG. 1, an explanation of “contact,” “duplicate contact,” and an example utilization of the invention is worthwhile. For instance, say “contact” Pam Richard has the following email addresses: pam.richard@gmail.com and pr@ibm.com. Further, say “contact” John Maio has only one email address, namely john.maio@maioconsulting.com. Now, assume someone wants to send the same email to both Pam and John, but duplicate copies of the same email to the same contact is not necessary. If this someone sends the same email to all three of the foregoing email addresses, which collectively comprise the EDL for this email whether the email addresses are listed in the “to” and/or “cc” field, then Pam would receive the email twice since two different email addresses for her are in the EDL for the email to be sent; hence, Pam is a “duplicate contact” for this email to be sent. Whether the someone readying to send the email unknowingly or even accidentally has one or more duplicate contacts in the EDL for an email to be sent, the multiple email address manager 130 detects and optionally removes an email address for any “duplicate contact” before sending the email. As can be easily imagined from the foregoing example, increasing the number of email addresses for an email to be sent and/or increasing the number of emails to be sent within a definite timeframe also likely increases the possible utilization of the multiple email address manager 130.

Returning now to a more detailed discussion about FIG. 1, the system 100 includes a computer system 105, such as a conventional computer, networked computer system, PDA, or cell phone. The computer system 105 includes an email client (“client”) for the user to compose, send and receive emails over wired or wireless communication 125 with a mail server 140 from/to at least another email client 170 on the same (as computer system 105) or a different computer system 160 that is in wired or wireless communication with the mail server 140. Each computer system 105, 160 normally includes non-depicted peripherals, such as a keyboard and a mouse, as well as non-depicted components including a microprocessors, memory, printers, CD-ROM devices, wires, antennas, IR wireless components, Bluetooth® components, and/or modems to connect 125 to one or more mail servers 140 and/or to connect 165 to another computer system 160. The email client 110, itself, is a software application, such as Outlook Express™, Netscape® Messenger™, Microsoft® Outlook®, Entourage X™, and Eudora®. A client 110, 170 usually includes an intuitive, graphical user interface (“GUI”) and a simple text editor that allows the user to create an email by opening a new message window and typing a text message via peripherals associated with the computer systems 105. In addition, a client 110, 170 normally includes simple spell checking and formatting facilities, as well as facilities to attach and detach email attachments to an email to be sent.

In the system 100, the computer system 105 includes the multiple email address manager 130 integrated, either locally or on an accessible server, into the email client 110 used to create an email with email addresses in an EDL 120. As discussed previously and in more detail later, the multiple email address manager 130 manages multiple email addresses by detecting and optionally removing one or more “duplicate contacts” in an email with email addresses in an EDL 120 to be sent. Here, by enabling logic reduced to software and/or hardware, the multiple email address manager 130 may pass the email with email addresses in a remaining EDL 150 to the mail server 140 from the email client 110. As a result, the multiple email address manager 130 may detect and optionally remove email addresses from the EDL for the email 120 so that no contact receives the email 120 more than once. Hence, email 120 has either an equivalent or smaller EDL as compared to email 150, and the potential difference between the two lead to their different denominations: “remaining EDL” for the former associated with email 150 and “EDL” for the latter and associated with email 120. From the mail server 140, email with email addresses in remaining EDL 150 is sent 165 to another email client 170 located on the same (as computer system 105) or different computer system 160, and that sent 165 email 150 is denominated email 180. Necessarily, email 180 is a contact in the remaining EDL as a result of the multiple email address manager 130 acting on the email with email address in EDL 120 from email client 110.

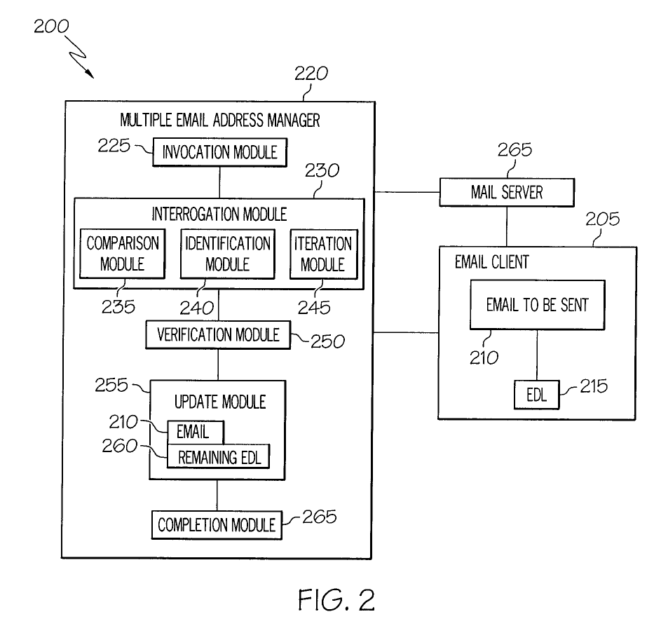

Now, moving to FIG. 2, a more detailed discussion of a system 200 for managing multiple email addresses for a contact ensues by disclosing components associated with and/or integrated into the multiple email manager 130 of FIG. 1 and/or FIG. 1 as a whole.

System 200 depicts a multiple email address manager 220, mail server 205 and email client 205 in communication with each other that may reside be part of a computer system such as that shown by FIG. 1. Although depicted separately for clarity, the software and/or hardware logic of the multiple email address manager 220 may, for instance, be integrated into an email client 210, may be a downloadable plug-in interacting with a web service, and may reside on either of the client or server side.

Turning to more discussion about FIG. 2, a user of the email client 205 may decide to draft an email to be sent 210 by entering two or more email addresses for the email 210. The two or more email addresses for the email 210 comprise the EDL 215 for that email 210. Working in tandem with the email client 205 is the invocation module 225 of the multiple email address manager 220. Through enabling software and/or hardware logic, the invocation module 225 initiates the management of multiple email addresses for the email to be sent 210. That is, the invocation module 220 invokes the multiple email address manager 220 to begin the overall process of detecting and updating whether a contact associated with each email address in the email to be sent 210 has a duplicate contact in the EDL 215. The invocation module 225 may invoke, for example, by a user of the email client 205 clicking or otherwise selecting a “send” button of the email client 205. In such an example, the user clicking the “send” button does not actually send the email 210; instead, clicking the “send” button invokes the invocation module 225 to begin the multiple email address manager 220 application, and, upon completion, a completion module 260, for instance, may either send the email directly or pass it back to the email client to send, where in either case the email to be sent 210 has an equal or smaller EDL than the original EDL 215 associated with the email to be sent 210. By way of another example, the invocation module 225 may not be invoked by the “send” button of the email client 210 in communication with the manager email address manager 220, but, instead, by a GUI or other accessible tool implemented into or associated with the email client 205. An example of such may appear in the email client 205 as a button called “invoker” or a drop-down table allowing selection of “start duplication check.”

Once the multiple email address manager 220 application is begun through the invocation module 235, the interrogation module 230 begins analysis of the EDL 215 associated with the email to be sent 210. Through coded and/or hardware-reduced logic, the interrogation module 230 compares, identifies, and iterates for duplicate contacts in the EDL 215 for the email to be sent 210. The comparison module 235 may perform the comparison through the most basic or complex algorithms so that at least one portion of each email address in the EDL 215 is compared to at least a portion of the other email addresses also in the EDL 215. For example, the comparison module 235 may compare names, shortnames, domains, or parts of an entire email address to give examples of basic algorithms. More complex algorithm examples would include comparing the contents of emails accessible and crawling such, to the email to be sent 210 and/or the EDL 215. In a possible complex algorithm example, the comparing may involve interrogating local emails, analyzing the contents, and building an index, metadata, or dictionary file, whereupon invoking the application 220 by the invocation module 225 would result in comparison module 235 comparing the email to be sent 210 to the pre-built index, metadata, or dictionary file for duplicate contacts in the EDL 215. The contents compared may, for example, key words, frequency, EDL, attachments, images, and so forth. Furthermore, through additional enabling logic associated with the integration module 230, the application 220 may permit the comparing to be based on user-defined key words or other user-defined parameters for assisting in the comparing by the comparison module 235. Furthermore, through query to a local address book, corporate address book, or other address book, values may be cross-referenced with known attributes. For example, an address of pam.richard@gmail.com may be associated with a contact name of “Pam Richard” in a local address book, and pr@ibm.com may be associated with the same contact name of “Pam Richard” in a local address book or query to a corporate address book, thereby indicating a likely duplicate contact.

The querying by the interrogation module 230 also involves identifying duplicate contacts through the comparing of the comparison module 235. This identifying is performed by the identification module 240 working in tandem with the comparison module 235. The identification module 240 identifies, for example, by automatically confirming or denying comparisons made by comparison module 235 based on pre-defined correlation parameters for the identification unless overridden by an optional verification module 250 that prompts a user for confirmation of an identified duplicate contact in the EDL 215 for the email to be sent 210. The pre-defined correlation parameters for the identifying, for example, may be set by the application 220 developer, an administrator for the application 220, or user-defined thresholds. To illustrate, enabling software and/or hardware for thresholds set by a developer, administrator or user may include setting a slider-bar that confirms a duplicate contact for a comparison between at least a portion of a first email to at least a portion of a second email, wherein both emails are in the EDL 215, when there is at least 90% similarity, wherein the associated logic may permit further granularity such as at least 90% similarity for the particular basic to complex algorithm(s) being used for the comparing by the comparison module 235. The iteration module 245 permits iterative functionalities of the comparison module 235 and identification module 240 until all of the duplicate contacts are identified in the EDL 215 of the email to be sent 210.

As previously discussed, the interrogation module 230 automatically confirms potential duplicate contacts based on settings that may be made within the application 220. Instead, or in addition to, logic associated with the verification module 250 may permit prompting the user with a dialog box, for instance, to confirm or deny whether an identified duplicate contact by the interrogation module 230 is correct. For instance, a dialog box may appear on the email client 210 saying, “pam.richard@gmail.com and pr@ibm.com—Duplicate? Ok or Cancel.” Here, selecting “Ok” would confirm that pam.richard@gmail.com and pr@ibm.com are duplicate contacts, i.e., both emails are for Pam Richard. If “Cancel” were chosen instead, then this would mean that pam.richard@gmail.com and pr@ibm.com are not duplicate contacts, which is not the case as previously discussed since both, in fact, are email addresses for the same contact, Pam Richard.

In communication with the interrogation module 230 and the optional verification module 250 is the update module 255. Through logic reduced to hardware and/or coded as software, the update module 255 updates the EDL 215 of the email to be sent 210 based on processing by the application's 220 interrogation module 230 and the optional verification module 250. Here, at the update module 255, the EDL 215 of the email to be sent 210 is replaced with the remaining EDL 260, which may be the same as EDL 215 or have fewer email addresses than EDL 215. Specifically, the update module 255 updates the EDL 215 by removing duplicate contacts, if any, passed to it by the interrogation module 240 and optional verification module 250. Building on the examples in the preceding paragraph that utilizes the optional verification module 250, the first example when “Ok” is selected would result in a duplicate contact for Pam Richard being identified in the EDL 215 for the email to be sent 210. The update module 255 may, for example, automatically remove one of the two email addresses for the contact, Pam Richards, to eliminate this duplicate contact in the EDL 215 for the remaining EDL 260 produced for the email to be sent 210. Or, the update module 255 may, for example, prompt the user to select which of the two email addresses for the contact, Pam Richards, to remove for this duplicate contact in the EDL 215 for the remaining EDL 260 produced for the email to be sent 210. As a result, it is readily apparent that the remaining EDL 260 now contains one email address rather than two as is the case with the EDL 215 prior to application's 220 update module's 255 processing. On the other hand, in the second example when “Cancel” is selected in the preceding paragraph, EDL 215 and EDL 255 are the same size, i.e., two email addresses, because the user of the verification module 250 decided, for whatever reason, that the application 220 should not recognize them, for the email to be sent 210 to pam.richard@gmail.com and pr@ibm.com, to be duplicate contacts even though the reader here knows that the email is being sent to the same contact, Pam Richard, at different email addresses.

Following the updating by the update module 255 of the EDL 215 to the remaining EDL 260 for the email to be sent 210, a completion module 265, in communication with the update module 255, includes enabling logic for allowing the email to be sent 210 with the remaining EDL 260. The completion module's 265 logic, for instance, may directly send the email with the remaining EDL 260, or, by way of another example, may pass the email to be sent 210 with the remaining EDL 260 back to the logic associated with the email client 210 for sending the email.

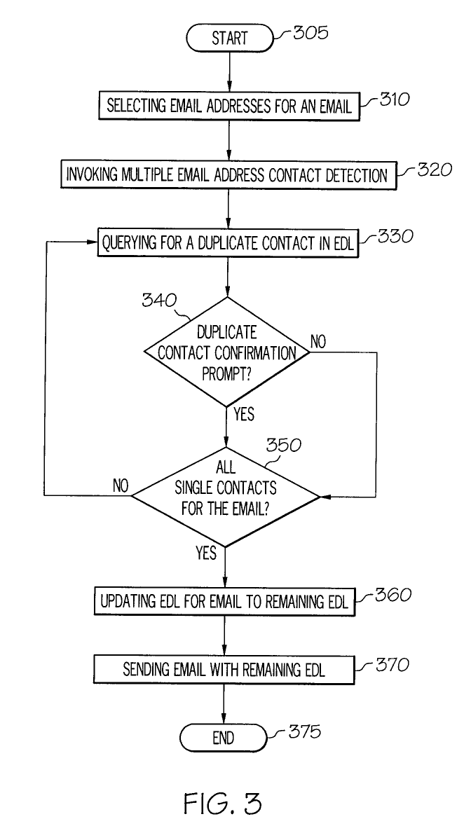

Turning now to FIG. 3, another aspect of the invention is disclosed. In particular, an embodiment of a flowchart 300 for managing multiple email addresses for a known contact is depicted. Flowchart 300 is for a system, such as systems 100 and 200, as shown in FIG. 1 and FIG. 2, respectively.

Flowchart 300 starts 305 by a user, for instance, selecting 310 email addresses for an email. The selecting 310 may be performed by clicking from a list or manually inserting email addresses into an email to be sent with an email client. After selecting 310 the email addresses for an email, wherein each email address is associated with a contact and collectively the email addresses comprise an email distribution list (“EDL”) for the email to be sent, invoking 320 multiple email address contact detection occurs. Through enabling logic found in software and/or hardware, the invoking 320 may occur, for example, by an email sender., e.g., a person, clicking on the send button on the email client associated with the application permitting the multiple email addresses manager application's invoking 320.

With the application invoked 320, further enabling logic queries 330 the email to be sent for a duplicate contact in its EDL. The querying 330 may occur using simple to complex algorithm(s) as previously discussed with a general aim at identifying duplicate contacts, i.e., different email addresses for the same contact in an EDL, for an email before such email is actually sent. FIG. 3 further shows decision block 340 following query 330, wherein the decision block 340 provides the option of prompting a user if a possibly identified duplicate contact is indeed a duplicate contact. Without this option 340, then the querying 330 of the EDL continues until there are all single contacts for the email to be sent. That is, if the all single contacts for the email decision block 350 is no, then the querying 330 continues until decision block 350 is yes. It should be understood that the “all single contacts for the email” decision block 350 title has limitations that may deviate from title's name of this decision block 350. For instance, if user-defined or preset thresholds for identifying duplicate contacts is too high or otherwise erroneous, or, improperly overridden by a user through denying a truly duplicate contact, then decision block 350 may actually pass duplicate contacts in the EDL prior to updating 360 EDL for the email to remaining EDL. Hence, a contact on the remaining EDL may still receive the email more than once at its multiple email addresses in the remaining EDL because it is not a “duplicate contact” as used in this disclosure. However, this apparent slippage of logic that may be associated with the multiple email address management application may be advantageous. For example, it still allows a user to send an email to a contact's multiple email addresses in the remaining EDL if the user wishes to override the application for some reason, such as to ensure the contact receives the email as soon as possible when it may not be known by the user which email account the contact will check next.

After the updating EDL by removing email addresses for a contact deemed to be a duplicate contact, the email may be sent 370 with the remaining EDL, which is either the same size or smaller than the EDL. The actual sending 370 of the email with the remaining EDL may be directly sent by the multiple email address management application or passed back to an associated email client for sending, whereupon in either example sending 370, the flowchart ends 375.

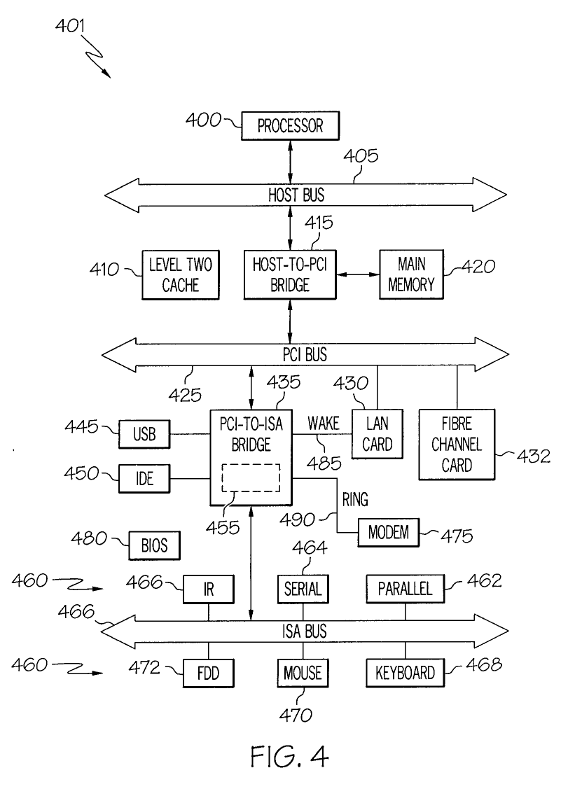

FIG. 4 illustrates information handling system 401 which is a simplified example of a computer system capable of performing the operations described herein. Computer system 401 includes processor 400 which is coupled to host bus 405. A level two (L2) cache memory 510 is also coupled to the host bus 405. Host-to-PCI bridge 415 is coupled to main memory 420, includes cache memory and main memory control functions, and provides bus control to handle transfers among PCI bus 425, processor 400, L2 cache 410, main memory 420, and host bus 405. PCI bus 425 provides an interface for a variety of devices including, for example, LAN card 430. PCI-to-ISA bridge 435 provides bus control to handle transfers between PCI bus 425 and ISA bus 440, universal serial bus (USB) functionality 445, IDE device functionality 450, power management functionality 455, and can include other functional elements not shown, such as a real-time clock (RTC), DMA control, interrupt support, and system management bus support. Peripheral devices and input/output (I/O) devices can be attached to various interfaces 460 (e.g., parallel interface 462, serial interface 464, infrared (IR) interface 466, keyboard interface 468, mouse interface 470, fixed disk (HDD) 472, removable storage device 474) coupled to ISA bus 440. Alternatively, many I/O devices can be accommodated by a super I/O controller (not shown) attached to ISA bus 440.

BIOS 480 is coupled to ISA bus 440, and incorporates the necessary processor executable code for a variety of low-level system functions and system boot functions. BIOS 480 can be stored in any computer readable medium, including magnetic storage media, optical storage media, flash memory, random access memory, read only memory, and communications media conveying signals encoding the instructions (e.g., signals from a network). In order to attach computer system 401 to another computer system to copy files over a network, LAN card 430 is coupled to PCI bus 425 and to PCI-to-ISA bridge 435. Similarly, to connect computer system 401 to an ISP to connect to the Internet using a telephone line connection, modem 475 is connected to serial port 464 and PCI-to-ISA Bridge 435.

While the computer system described in FIG. 4 is capable of executing the invention described herein, this computer system is simply one example of a computer system. Those skilled in the art will appreciate that many other computer system designs are capable of performing the invention described herein.

Another embodiment of the invention is implemented as a program product for use within a device such as, for example, devices 100 and 200 shown in FIG. 1 and FIG. 2. The program(s) of the program product defines functions of the embodiments (including the methods described herein) and can be contained on a variety of data-bearing media. Illustrative data-bearing media include, but are not limited to: (i) information permanently stored on non-writable storage-type accessible media (e.g., read-only memory devices within a computer such as CD-ROM disks readable by a CD-ROM drive); (ii) alterable information stored on writable storage-type accessible media (e.g., floppy disks within a diskette drive or hard-disk drive); and (iii) information conveyed to a computer by a communications medium, such as through a computer or telephone network, including wireless communications. The latter embodiment specifically includes information downloaded onto either permanent or even sheer momentary storage-type accessible media from the World Wide Web, an internet, and/or other networks. Such data-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

While the foregoing is directed to example embodiments of the disclosed invention, other and further embodiments of the invention may be devised without departing from the basic scope thereof, and the scope thereof is determined by the claims that follow.

What is claimed is:

1. A method for managing multiple email addresses, the method comprising:
selecting email addresses for an email to be sent through a computer system in communication with a mail server, wherein the email addresses comprise an email distribution list;
querying, before sending the email, for duplicate contacts associated with any of the email addresses in the email distribution list for the email;
updating, after the querying, the email distribution list to the email addresses left in a remaining email distribution list produced through removal, if any, of the duplicate contacts identified by the querying; and
the sending the email to contacts associated with each of the email addresses in the remaining email distribution list in communication with the mail server.

2. The method of claim 1, further comprising invoking the method by selecting “send” on an email client in communication with the computer system.

3. The method of claim 1, further comprising prompting, after the querying, for confirmation of each, if any, of the duplicate contacts identified by the querying.

4. The method of claim 1, wherein the querying comprises iterating the querying until none of the duplicate contacts are left in the remaining email distribution list before the sending.

5. The method of claim 1, wherein the querying comprises comparing at least one portion of each of the email addresses in the email distribution list to the at least one portion of the email addresses also in the email distribution list.

6. The method of claim 1, wherein the querying comprises comparing content of emails to the emails in the email distribution list.

7. The method of claim 1, wherein the updating comprises removing at least one of the duplicate contacts from the email distribution list.

8. A system for managing multiple email addresses, the method comprising:
email addresses selected for an email to be sent through a computer system having an email client and in communication with a mail server, wherein the email addresses comprise an email distribution list;
an interrogation module, associated with the email client, for querying, before sending the email, for duplicate contacts associated with any of the email addresses in the email distribution list for the email;
an update module, associated with the interrogation module, for updating the email distribution list to the email addresses left in a remaining email distribution list produced through removal, if any, of the duplicate contacts identified by the querying by the interrogation module; and
a completion module for sending the email to contacts associated with each of the email addresses in the remaining email distribution list in communication with the mail server.

9. The system of claim 8, further comprising an invocation module, associated with the email client, for invoking the system by selecting “send” on the email client.

10. The system of claim 8, further comprising a verification module, associated with the interrogation module and the update module, for prompting for confirmation of each, if any, of the duplicate contacts identified by the querying by the interrogation module.

11. The system of claim 8, wherein the interrogation module comprises an iteration module for iterating the querying until none of the duplicate contacts are left in the remaining email distribution list before the sending of the email.

12. The system of claim 8, wherein the interrogation module comprises a comparison module for comparing at least one portion of each of the email addresses in the email distribution list to the at least one portion of the email addresses also in the email distribution list.

13. The system of claim 8, wherein the interrogation module comprises a comparison module for comparing content of emails to the emails in the email distribution list.

14. The system of claim 8, wherein the update module comprises removing at least one of the duplicate contacts from the email distribution list.

15. A storage-type accessible medium containing instructions, which when executed by a machine, cause the machine to perform operations for managing multiple email addresses, comprising:
selecting email addresses for an email to be sent through a computer system in communication with a mail server, wherein the email addresses comprise an email distribution list;
querying, before sending the email, for duplicate contacts associated with any of the email addresses in the email distribution list for the email;
updating, after the querying, the email distribution list to the email addresses left in a remaining email distribution list produced through removal, if any, of the duplicate contacts identified by the querying; and
the sending the email to contacts associated with each of the email addresses in the remaining email distribution list in communication with the mail server.

16. The storage-type accessible medium of claim 15, wherein the instructions further comprise operations for invoking the instructions by selecting “send” on an email client in communication with the computer system.

17. The storage-type accessible medium of claim 15, wherein the instructions further comprise operations for prompting, after the querying, for confirmation of each, if any, of the duplicate contacts identified by the querying.

18. The storage-type accessible medium of claim 15, wherein the instructions for querying comprise iterating the querying until none of the duplicate contacts are left in the remaining email distribution list before the sending.

19. The storage-type accessible medium of claim 15, wherein the instructions for querying comprise comparing at least one portion of each of the email addresses in the email distribution list to the at least one portion of the email addresses also in the email distribution list.

20. The storage-type accessible medium of claim 15, wherein the instructions for querying comprise comparing content of emails to the emails in the email distribution list.
